(19) United States
(12) Patent Application Publication
(10) Pub. No.: US 2009/0267899 A1
(43) Pub. Date: Oct. 29, 2009

(54) OPTICAL SENSOR MODULE FOR OPTICAL POINTING DEVICE AND METHOD OF FABRICATING THE SAME

(75) Inventors: Wan-Gyo Jeong, Seongnam-si (KR); Bang-Won Lee, Yongin-si (KR); Sung-Hyuk Hong, Yongin-si (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/374,093

(22) PCT Filed: Nov. 8, 2006
(86) PCT No.: PCT/KR2006/004659

§ 371 Date: Jan. 16, 2009

(30) Foreign Application Priority Data
Jul. 20, 2006 (KR) 10-2006-0068049

(51) Int. Cl. G06F 3/033

(52) U.S. Cl. 345/166

(57) ABSTRACT

An optical sensor module for an optical pointing device and a method of fabricating the same are provided. The optical sensor includes: a lead frame having a light receiving hole formed in a pad; an image sensor attached to the pad and detecting light emitted from a light source through the light receiving hole; and a molding member for integrally molding the lead frame and the image sensor. The method includes: forming a light receiving hole in a pad of a lead frame; attaching an image sensor to the pad; connecting the image sensor to a lead of the lead frame by bonding using a wire; molding the lead frame and the image sensor; and trimming the lead of the lead frame to a certain length and forming the lead.

### TECHNICAL FIELD

The present invention relates to an optical sensor module for an optical pointing device and a method of fabricating the same, and more particularly, to an optical sensor module for an optical pointing device and a method of fabricating the same capable of reducing the number of working processes and improving productivity by simplifying the optical sensor module fabricating method, and improving optical sensitivity by preventing interference due to diffused reflection of incident light.

### BACKGROUND ART

Generally, an optical pointing device is referred to as a device such as an optical mouse, a presentation input device, a joystick, a finger pointing device, or the like, in which an optical sensor is installed.

Describing a conventional mouse as an example, the mouse is one of input devices of a computer such as a keyboard, and so on, for providing position information of a cursor moved by a user to a computer to display the position information through a display device, thereby inputting relevant data while verifying the position.

The mouse may be classified into a ball mouse for providing position information using a ball, an optical mouse for providing position information on the basis of variation of luminous intensity, a pen mouse using a pen, or the like, according to its driving method.

Among them, since the optical mouse very rapidly and precisely detects position information in comparison with the ball mouse, it is very widely used nowadays. The optical mouse includes a light source disposed in a housing to emit light to a work surface, an optical sensor module 1 for sensing light reflected by the work surface, a plurality of buttons, and a scroll wheel.

In particular, the optical sensor module 1, a major component of the optical mouse, is fabricated by a method shown in FIGS. 1 to 6. First, as shown in FIG. 1, a lead frame 2 is provided. Then, as shown in FIG. 2, the lead frame 2 is molded to expose one side of a pad 2a, thereby forming a reception part 3. As shown in FIG. 3, an image sensor 4 is installed at the pad 2a exposed in the reception part 3. Then, as shown in FIG. 4, the image sensor 4 is bonded to a lead 2b of the lead frame 2 by a wire 5.

In addition, as shown in FIG. 5, a cap 6 is covered on an upper part after bonding the wire 5, and then, as shown in FIG. 6, the lead 2b is trimmed and formed, thereby completing the optical sensor module 1.

As described above, the lead frame 2 should be molded to form the reception part 3, in which the image sensor 4 can be installed. Therefore, the cap 6 is additionally required to cover the reception part 3 and protect the wire 5. As a result, in order to detect light through the cap 6, a capping process of forming an incident hole at the cap 6 and joining the cap 6 should be added, thereby decreasing productivity.

In addition, insufficient bonding of the wire may cause an open failure due to external impact when the module is dropped or the cap is removed, thereby abruptly decreasing durability.

### DISCLOSURE

### Technical Problem

In order to solve the above problems, the present invention provides an optical sensor module for an optical pointing device and a method of fabricating the same capable of simplifying the structure of the optical sensor module and increasing durability thereof.

The present invention also provides an optical sensor module for an optical pointing device and a method of fabricating the same capable of improving optical sensitivity by preventing interference due to diffused reflection of incident light.

The present invention also provides an optical sensor module for an optical pointing device and a method of fabricating the same capable of reducing the number of working processes of fabricating the optical sensor module to increase productivity.

### Technical Solution

According to an aspect of the present invention, an optical sensor module for an optical pointing device comprises: a lead frame having a light receiving hole formed in a pad; an image sensor attached to the pad and detecting light emitted from a light source through the light receiving hole; and a molding member for integrally molding the lead frame and the image sensor.

In this process, the image sensor may be disposed at the pad apposite to the light source such that a sensing region of the image sensor is directed to the light receiving hole.

In addition, the molding member may have a transmission hole in communication with the light receiving hole such that the incident light enters through the light receiving hole.

Further, the light receiving hole may be equal to or larger than the sensing region of the image sensor.

Furthermore, an adhesion layer may be disposed between the image sensor and the pad.

In addition, the light receiving hole may have a first anti-diffused reflection layer for preventing diffused reflection of the incident light, and the pad of the lead frame may have a second anti-diffused reflection layer for preventing diffused reflection of the incident light.

At this time, the first and second anti-diffused reflection layers may form surfaces of the light receiving hole and the pad formed on one selected from a coating layer formed of an anti-diffused reflection film, a corroded layer formed by corrosion treatment, and a material for preventing diffused reflection.

In addition, the optical sensor module may further comprise a cap adhered to the molding member toward the light source, and having an incident hole for entering light into the sensing region of the image sensor.

In this process, the cap may be adhered to the molding member, and the incident hole may have a sloped part expanding toward the image sensor.

According to another aspect of the present invention, a method of fabricating an optical sensor module for an optical pointing device comprises: forming a light receiving hole in a pad of a lead frame; attaching an image sensor to the pad; connecting the image sensor to a lead of the lead frame by bonding using a wire; molding the lead frame and the image sensor; and trimming the lead of the lead frame to a certain length and forming the lead.

In this process, attaching the image sensor may further comprise adhering a two-sided adhesion tape onto the pad to attach the image sensor to the pad.

In addition, the molding step may be performed to form a transmission hole in communication with the light receiving hole.

Further, the molding step may comprise forming a layer for preventing contamination of the sensing region of the image sensor using a taping or coating process when the lead frame and the image sensor are molded.

The method may further comprise removing the anti-contamination layer formed by the anti-contamination layer forming step, after the molding step.

In addition, the method may further comprise finely removing the sensing region contaminated by foreign substances, after the molding step.

Further, forming the light receiving hole may further comprise forming an anti-diffused reflection layer to prevent diffused reflection of the pad and the light receiving hole formed in the pad, and forming the anti-diffused reflection layer may be performed by one of coating and corroding processes, or using an anti-diffused reflection material.

Furthermore, the method may further comprise adhering a cap having an incident hole to determine an incident region of the trimmed and formed optical sensor.

### ADVANTAGEOUS EFFECTS

An optical sensor module for an optical pointing device includes a lead frame, an image sensor, a wire, and a molding member, and is integrally formed with each other by the molding member, thereby simplifying constitution and improving durability.

In addition, it is possible to improve sensitivity of an image sensor and reliability of the optical pointing device by preventing interference due to diffused reflection of incident light using an anti-diffused reflection layer.

Further, it is possible to omit a capping step and a cap cleaning step by forming a light receiving hole at a lead frame and simultaneously forming a transmission hole during a molding step, thereby reducing the number of working processes and improving productivity.

### BRIEF DESCRIPTION OF DRAWINGS

These and/or other aspects and advantages of the present invention will become apparent and more readily appreciated from the following description of the embodiments, taken in conjunction with the accompanying drawings of which:

FIGS. 1 to 6 are cross-sectional views showing processes of fabricating a conventional optical sensor module for an optical pointing device;

FIG. 7 is a cross-sectional view of a mouse including an optical sensor module in accordance with an exemplary embodiment of the present invention;

FIG. 8 is an enlarged cross-sectional view of an optical sensor module in accordance with an exemplary embodiment of the present invention;

FIG. 9 is a cross-sectional view of an optical sensor module adhered to a cap in accordance with an exemplary embodiment of the present invention;

FIG. 10 is a flowchart showing a method of fabricating an optical sensor module in accordance with an exemplary embodiment of the present invention; and

FIG. 11 to 15 are cross-sectional views showing a method of fabricating an optical sensor module in accordance with an exemplary embodiment of the present invention.

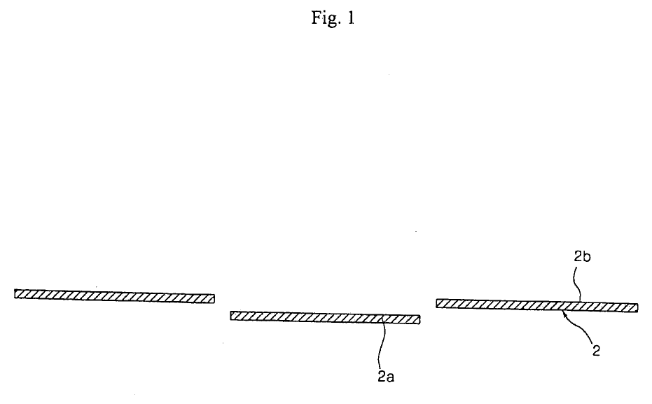

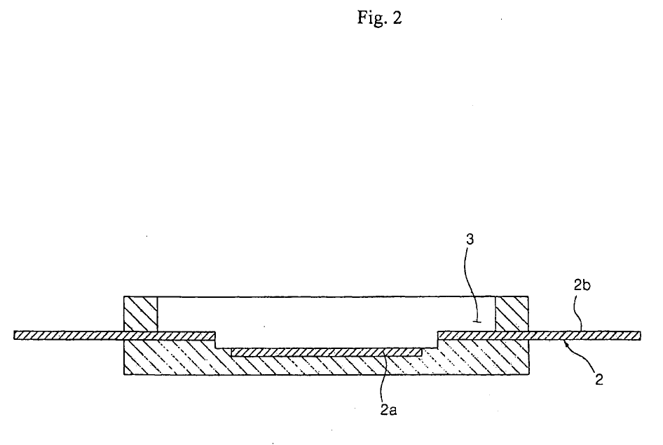

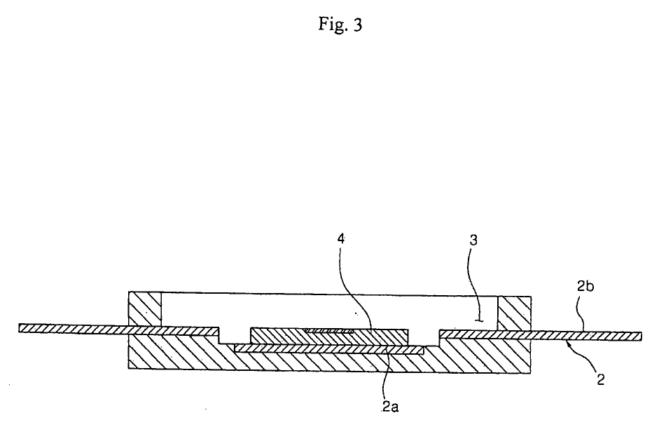

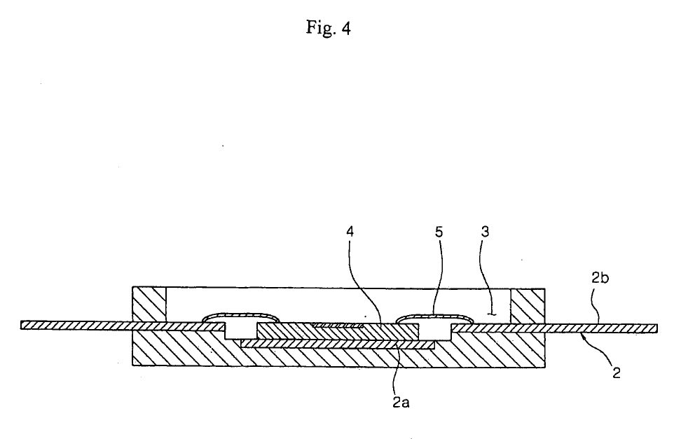

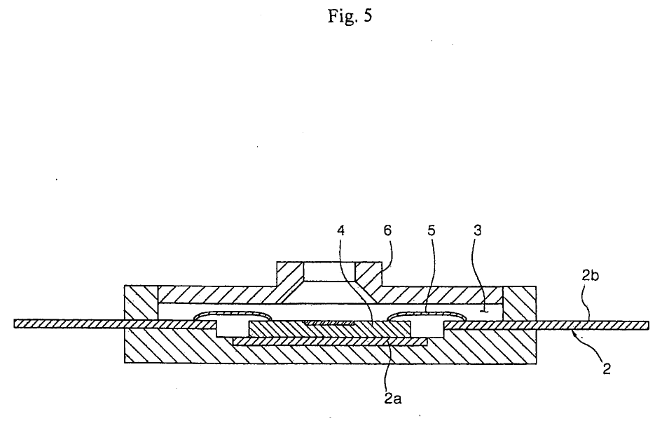

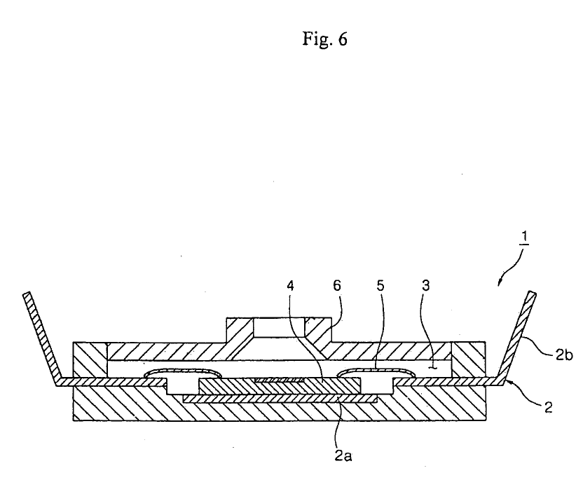

* Description of Major Symbols in the above Figures

| | |
|---|---|
| 100: | Optical sensor module |
| 10: | Lead frame |
| 11: | Pad |
| 12: | Lead |
| 13: | Light receiving hole |
| 20: | Image sensor |
| 21: | Sensing region |
| 30: | Molding member |
| 31: | Transmission hole |
| 40: | Adhesive layer |
| 50, 51, 52: | Anti-diffused reflection layer |
| 60: | Cap |
| 61: | Incident hole |
| 62: | Sloped part |

### MODES OF THE INVENTION

Reference will now be made in detail to exemplary embodiments of the present invention, which are illustrated in the accompanying drawings.

The embodiments are described below in order to explain the present invention by referring to the figures.

Here, an optical pointing device is referred to as a device such as an optical mouse, a presentation input device, a joystick, a finger pointing device, or the like, in which an optical sensor is installed. Hereinafter, the optical mouse will be described for the convenience of description.

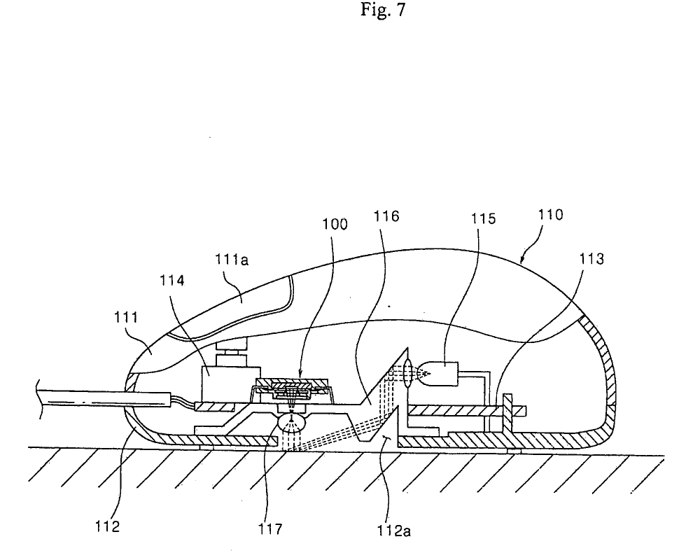

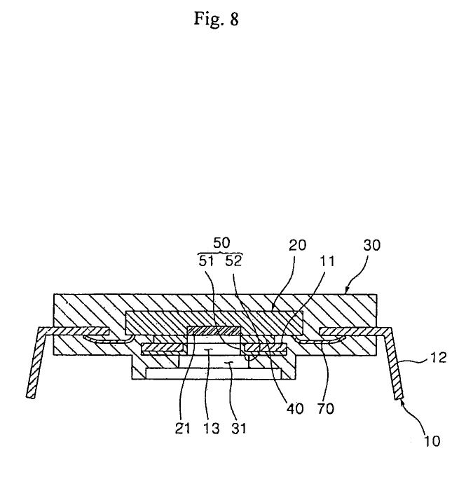

FIG. 7 is a cross-sectional view of a mouse 110 including an optical sensor module 100 in accordance with an exemplary embodiment of the present invention, and FIG. 8 is an enlarged cross-sectional view of the optical sensor module 100 in accordance with an exemplary embodiment of the present invention.

As shown in FIGS. 7 and 8, the optical sensor module 100 is installed in the mouse 110. Briefly describing the mouse, the mouse 110 includes upper and lower housings 111 and 112, a PCB 113 disposed in the housings 111 and 112, a switch 114 mounted on the PCB 113, an optical sensor module 100, and a light source 115 for emitting light.

Here, the upper housing 111 includes a button 111a in resilient contact with the switch 114, and the lower housing 112 includes a through-hole 112a for allowing light emitted from the light source 115 to be reflected from a work surface and then detected by the optical sensor module 100, a light guide member 116 for guiding light emitted from the light source 115 through the through-hole 112a to the work surface, and a lens 117 for entering the light reflected from the work surface into the optical sensor module 100.

Therefore, the light emitted from the light source 115 is guided by the light guide member 116 to irradiate the work surface, and the irradiated light is reflected from the work surface to enter into the optical sensor module 100 through the lens 117.

Then, the entered light is detected by the optical sensor module 100 as an image. At this time, when the mouse 110 moves, the movement of the mouse 110 is converted into position information of X and Y coordinates from correlation of the images, then the position information is transferred to a computer.

The optical sensor module 100 includes a molding member 30, a lead frame 10, and an image sensor 20. The molding member 30 is formed of epoxy resin to surround the optical sensor module 100, and the lead frame 10 and the image sensor 20 are installed in the molding member 30.

The lead frame 10 is formed of a conductive material, and includes a plurality of leads 12 mounted on a PCB, and pad 11 disposed between the leads 12. Pad 11 is disposed higher than the lead 12 (projecting downward in the drawings), and has a predetermined size of light receiving hole 13 at its center to pass through the light. In addition, the image sensor 20 is connected to one side of the pad 11 having the light receiving hole 13.

Further, the image sensor 20 adhered to the pad 11 is formed by a semiconductor manufacturing process, and formed of a CCD or CMOS image sensor 20 to detect the incident light.

At this time, the image sensor 20 is attached to the pad 11 through the medium of an adhesive layer 40 formed on the pad 11.

In addition, the image sensor 20 has a sensing region 21 for detecting the reflected and entered light, and adhered corresponding to the light receiving hole 13 such that the sensing region 21 is positioned at the light receiving hole 13. Therefore, the light entering through the light receiving hole 13 can be detected in the sensing region 21.

At this time, the light receiving hole 13 is equal to or larger than the sensing region 21, and adhered to be positioned at a center part of the sensing region. In addition, the light entering through the light receiving hole 13 is diffusedly reflected by the lead frame 10 formed of a conductive material to enter into the sensing region 21.

As a result, the light entering from the work surface and the light entering by the diffused reflection may be mixed with each other to generate errors. Therefore, in order to prevent diffused reflection of the entering light, a anti-diffused reflection layer 50 for preventing diffused reflection should be formed.

The anti-diffused reflection layer 50 includes a first anti-diffused reflection layer 51 formed on the inner periphery of the light receiving hole 13, and a second anti-diffused reflection layer 52 disposed around the light receiving hole 13 and formed on one surface of the pad 11 directed to the light source.

In this process, the first and second anti-diffused reflection layers 51 and 52 may be formed by coating an anti-diffused reflection material or an anti-diffused reflection film on the light receiving hole 13 and the pad 11, or formed by corroding the light receiving hole 13 and the pad 11. In addition, the first and second anti-diffused reflection layers 51 and 52 may be formed of a material for preventing diffused reflection.

Further, the image sensor 20 is connected to the leads 12 of the lead frame 10 by bonding both ends of the wire 70. In a state that the wire 70 is connected, the molding member 30 is molded to be adhered to the image sensor 20 and the lead frame 10.

At this time, the molding member 30 is molded to form a transmission hole 31 in communication with the light receiving hole 13 so that the incident light passes through the transmission hole 31. In this process, the transmission hole 31 is equal to or larger than the light receiving hole 13.

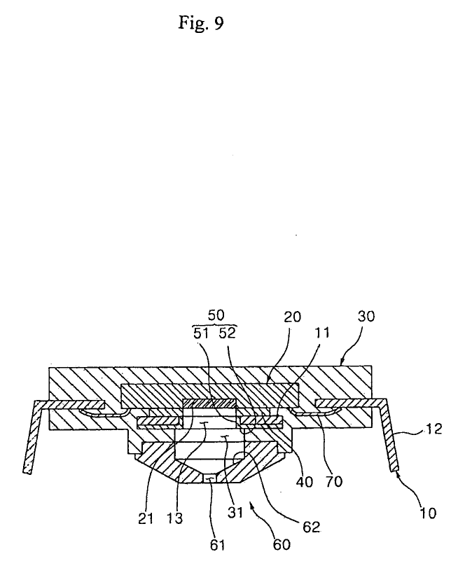

Meanwhile, a cap 60 may be disposed to allow the light to enter through a lens installed in the mouse 110 as shown in FIG. 9. FIG. 9 is a cross-sectional view of an optical sensor module adhered to the cap 60 in accordance with an exemplary embodiment of the present invention.

As shown in FIG. 9, the cap 60 is fixedly adhered to the molding member 30, and has an incident hole 61 formed at its center for entering light. Here, the cap 60 is adhered to the molding member 30, but it is natural that the cap 60 is also adhered to the light guide member 116 or the lens 117 installed in the mouse 110.

Therefore, light passes through the incident hole 61, the transmission hole 31, and the light receiving hole 13 to enter into the sensing region 21 of the image sensor 20. Then, the entering image is detected to be input into a computer as a position information signal of X and Y variations. At this time, the incident hole 61 has a sloped part 62 extending toward the image sensor 20.

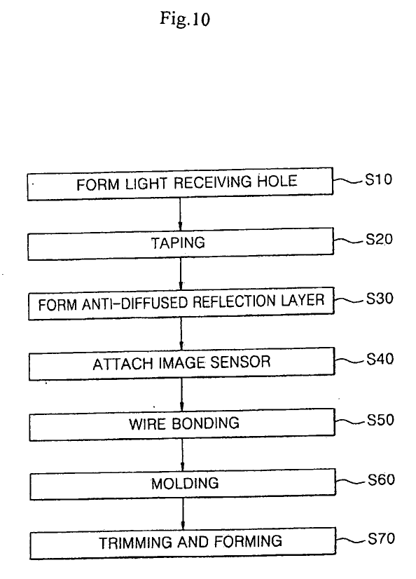

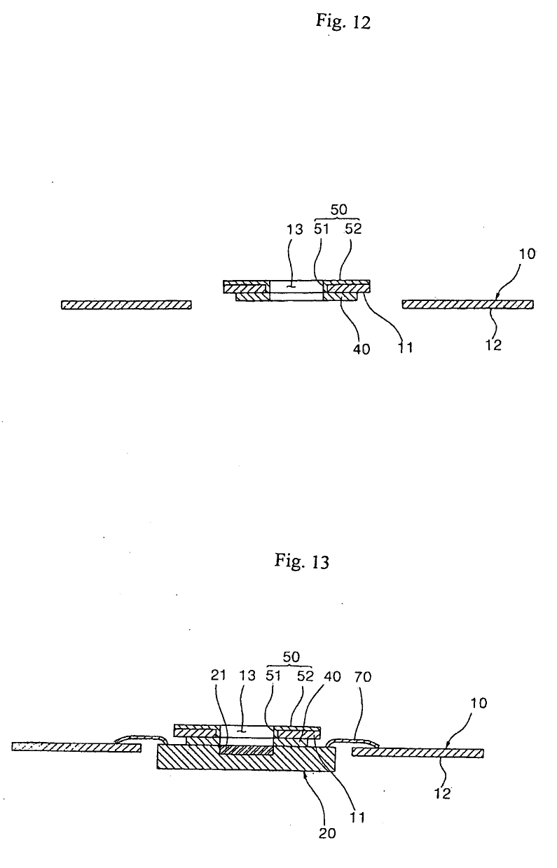

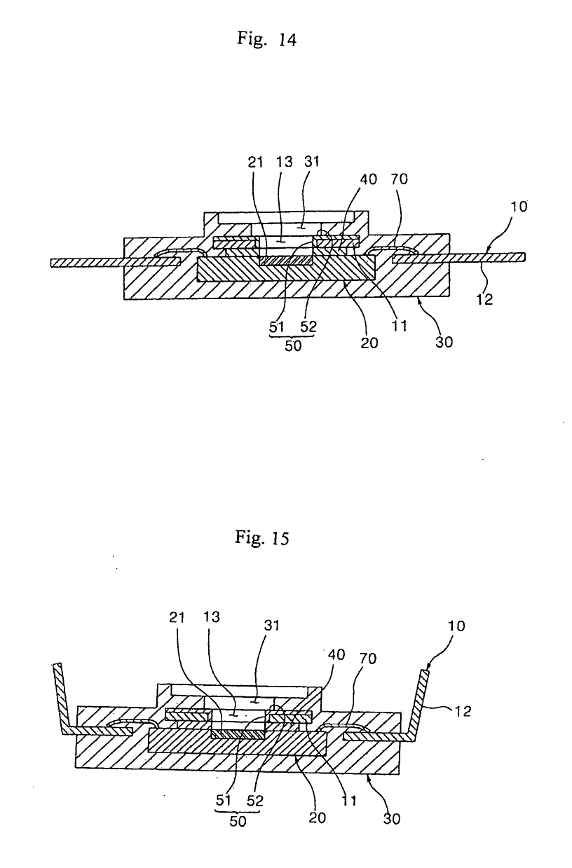

A method of manufacturing an optical sensor for an optical pointing device in accordance with an exemplary embodiment of the present invention will now be described with reference to FIGS. 10 to 15.

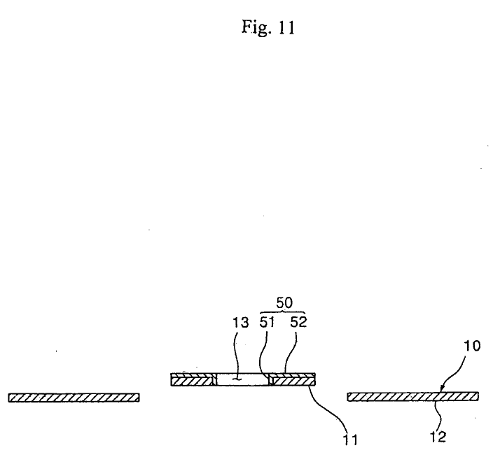

FIG. 10 is a flowchart showing a method of fabricating an optical sensor module in accordance with an exemplary embodiment of the present invention, and FIGS. 11 to 15 are cross-sectional views showing a method of fabricating an optical sensor module in accordance with an exemplary embodiment of the present invention.

As shown in FIGS. 10 to 15, since the optical sensor module is manufactured in a reversed state as shown in FIG. 11, a reversed lead frame 10 is provided. Then, a predetermined size of light receiving hole 13 is formed at a center part of a pad 11 of the lead frame 10 (S10). The light receiving hole 13 is preferably formed at the center part of the pad 11, because the light receiving hole 13 may be eccentrically formed in the pad 11 when the image sensor 20 is eccentrically disposed at the sensing region 21.

Then, since the light may be diffusedly reflected by one surface of the light receiving hole 13 of the lead frame 10 and the pad 11 directed to the light source to enter into the sensing region 21, an anti-diffused reflection layer 50 is formed to prevent diffused reflection of the incident light (S20).

In this process, the anti-diffused reflection layer 50 may have a coating layer coated with an anti-diffused reflection material or an anti-diffused reflection film, or a corrosion layer formed by corroding the light receiving hole 13 and the pad 11. In addition, the anti-diffused reflection layer 50 may be formed of a material for preventing diffused reflection.

Then, an image sensor 20 is attached to the pad 11 of the lead frame 10. Here, in order to attach the image sensor 20 to the pad 11, an adhesive layer 40 is formed (S30). Next, the image sensor 20 is attached to the pad 11 by the adhesive layer 40 (S40). In this process, the image sensor 20 is attached such that the sensing region 21 is directed to the light receiving hole 13.

Then, the image sensor 20 and the lead 12 of the lead frame 10 are connected to each other by bonding both ends of a wire 70 (S50).

After the wire bonding, the lead frame 10, the wire 70, and the image sensor 20 are molded together (S60). At this time, the molding process is simultaneously performed while forming a transmission hole 31 for entering light through the light receiving hole 13. That is, the transmission hole 31 is formed together during the molding.

Therefore, the lead frame 10, the wire 70, and the light receiving member can be integrally and securely fixed to each other.

When the lead frame 10 and the image sensor 20 are molded during step S60, in order to prevent contamination of the sensing region 21 of the image sensor 20 due to foreign substances, a step of forming an anti-contamination layer for protecting the sensing region 21 by a taping or coating process may be performed before step S60.

In addition, when the anti-contamination layer forming step is performed, a step of removing the anti-contamination layer may be performed after step S60.

In addition, a cleaning step of finely removing the sensing region contaminated by foreign substances until the molding step may be performed after the molding step. In this process, the cleaning step may be an etching step.

Then, the lead 12 of the lead frame 10 is cut into predetermined lengths, and bent into a certain shape to be installed on a PCB, thereby completing the optical sensor module 100 (S70). It is natural that the lead frame 10 can be made in other IC package forms such as leadless package and surface mounted package.

Next, if necessary, a cap 60 may be adhered to the molding member 30. The cap 60 may have a predetermined groove to be adhered to the molding member 30, an adhesive layer may be formed on the groove, and the cap 60 may be adhered to the molding member 30 during the following manufacturing process, after integrally forming the cap with a lens.

An optical sensor module for an optical pointing device and a method of manufacturing the same in accordance with an exemplary embodiment of the present invention were described with reference to the accompanying drawings, but not limited thereto. Of course, the present invention may be applied to a general image sensor.

### INDUSTRIAL APPLICABILITY

As can be seen from the foregoing, an optical sensor module for an optical pointing device includes a lead frame, an image sensor, a wire, and a molding member, and is integrally formed with each other by the molding member, thereby simplifying constitution and improving durability.

In addition, it is possible to improve sensitivity of an image sensor and reliability of the optical pointing device by preventing interference due to diffused reflection of incident light using an anti-diffused reflection layer.

Further, it is possible to omit a capping step and a cap cleaning step by forming a light receiving hole at a lead frame and simultaneously forming a transmission hole during a molding step, thereby reducing the number of working processes and improving productivity.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An optical sensor module for an optical pointing device, comprising:
a lead frame having a light receiving hole formed in a pad;
an image sensor attached to the pad and detecting light emitted from a light source through the light receiving hole; and
a molding member for integrally molding the lead frame and the image sensor.

2. The optical sensor module for an optical pointing device according to claim 1, wherein the image sensor is disposed at the pad apposite to the light source such that a sensing region of the image sensor is directed to the light receiving hole.

3. The optical sensor module for an optical pointing device according to claim 1, wherein the molding member has a transmission hole in communication with the light receiving hole such that the incident light enters through the light receiving hole.

4. The optical sensor module for an optical pointing device according to claim 1, wherein the light receiving hole is equal to or larger than a photo sensing region of the image sensor.

5. The optical sensor module for an optical pointing device according to claim 1, wherein an adhesion layer is disposed between the image sensor and the pad.

6. The optical sensor module for an optical pointing device according to claim 1, wherein the light receiving hole has a first anti-diffused reflection layer for preventing diffused reflection of the incident light.

7. The optical sensor module for an optical pointing device according to claim 1, wherein the pad of the lead frame has a second anti-diffused reflection layer for preventing diffused reflection of the incident light.

8. The optical sensor module for an optical pointing device according to claim 6, wherein the anti-diffused reflection layer is coating layers coated with an anti-diffused reflection film.

9. The optical sensor module for an optical pointing device according to claim 6, wherein the anti-diffused reflection layer is corroded layers.

10. The optical sensor module for an optical pointing device according to claim 6, wherein the anti-diffused reflection layer form surfaces of the light receiving hole and the pad using a material for preventing diffused reflection.

11. The optical sensor module for an optical pointing device according to claim 1, further comprising a cap adhered to the molding member toward the light source, and having an incident hole for entering light into the sensing region of the image sensor.

12. The optical sensor module for an optical pointing device according to claim 11, wherein the cap is adhered to the molding member.

13. The optical sensor module for an optical pointing device according to claim 11, wherein the incident hole has a sloped part expanding toward the image sensor.

14. A method of fabricating an optical sensor module for an optical pointing device, comprising:
forming a light receiving hole in a pad of a lead frame;
attaching an image sensor to the pad; connecting the image sensor to a lead of the lead frame by bonding using a wire;
molding the lead frame and the image sensor; and
trimming the lead of the lead frame to a certain length and forming the lead.

15. The method according to claim 14, wherein attaching the image sensor to the pad further comprises adhering a two-sided adhesion tape onto the pad to attach the image sensor to the pad.

16. The method according to claim 14, wherein the molding step is performed to form a transmission hole in communication with the light receiving hole.

17. The method according to claim 14, wherein the molding step comprises forming a layer for preventing contamination of the sensing region of the image sensor using one of taping and coating processes when the lead frame and the image sensor are molded.

18. The method according to claim 17, further comprising removing the anti-contamination layer formed in the anti-contamination layer forming step, after the molding step.

19. The method according to claim 17, further comprising finely removing the sensing region contaminated by foreign substances until the molding step, after the molding step.

20. The method according to claim 17, wherein forming the light receiving hole further comprises forming an anti-diffused reflection layer to prevent diffused reflection of the pad and the light receiving hole formed in the pad.

21. The method according to claim 20, wherein forming the anti-diffused reflection layer is performed by one of coating and corroding processes, or using an anti-diffused reflection material.

22. The method according to claim 17, further comprising adhering a cap having an incident hole to determine an incident region of the trimmed and formed optical sensor.

23. The optical sensor module for an optical pointing device according to claim 17, wherein the anti-diffused reflection layer is coating layers coated with an anti-diffused reflection film.

24. The optical sensor module for an optical pointing device according to claim 23, wherein the anti-diffused reflection layer is corroded layers.

25. The optical sensor module for an optical pointing device according to claim 17, wherein the anti-diffused reflection layer form surfaces of the light receiving hole and the pad using a material for preventing diffused reflection.
